(19) United States
(12) Patent Application Publication
(10) Pub. No.: US 2026/0015490 A1
(43) Pub. Date: Jan. 15, 2026

(54) Rubber Compositions Containing Phloroglucinolic Resins for Use in Tire Treads of Heavy Vehicles

(71) Applicants: Sumitomo Chemical Advanced Technologies, LLC. D.B.A. Sumika Electronic Materials, Phoenix, AZ (US); Sumitomo Chemical Company Limited, Tokyo (JP)

(72) Inventors: Toshihiro NOBUOKA, Kashiwa-city, Chiba (JP); Mari Diata V KEITA, Pittsburgh, PA (US)

(21) Appl. No.: 18/994,273

(22) PCT Filed: Jul. 14, 2023
(86) PCT No.: PCT/US2023/070198

§ 371 Date: Jan. 14, 2025

Related U.S. Application Data
(60) Provisional application No. 63/389,127, filed on Jul. 14, 2022.

(51) Int. Cl. C08L 7/00; B60C 1/00; C08J 3/20; C08J 3/24; C08K 3/06; C08K 3/36; C08K 9/06

(52) U.S. Cl. CPC C08L 7/00; B60C 1/0016; C08J 3/203; C08J 3/247; C08K 3/06; C08K 3/36; C08K 9/06; C08J 2307/00; C08J 2461/16

(57) ABSTRACT

A silane-based additive, rubber formulations including the additive and tires having tread portions made with the additive, together with methods of forming those products, are provided. Uncured rubber formulations in accordance with preferred embodiments of the invention comprise (1) a rubbery primary polymer or polymer blend, such as natural rubber and/or synthetic rubber; (2) reinforcing silica filler; (3) methylene donor compound; (4) a silane containing one or more moieties of the aforementioned network forming polymer. And (5) phloroglucinol resin. In particular networks which can be generated in-situ are preferred. The cured rubber formulation should comprise the silica, having the load-bearing-path reinforcing interpenetrating polymer network coupled thereto, within the rubber matrix, and not directly to the rubber chains via sulfidic linkages.

### FIELD OF THE INVENTION

This invention relates generally to a rubber compound for use in tires of heavy vehicles such as large truck and bus. More specifically, the present invention relates to an eco-friendly, fuel-efficient rubber compound for use in the treads of truck and bus tires that does not include resorcinol, but unexpectedly provides superior rolling resistance properties for such rubber compounds.

### BACKGROUND OF THE INVENTION

Due to Corporate Average Fuel Economy (CAFE) standards, the Greenhouse Gas (GHG) protocol, and other legislations promulgated by the National Highway Transportation Safety Administration (NHTSA) and the Environmental Protection Agency (EPA) in the United States, as well as regulations promulgated by Transportation Canada and the Canadian Health Ministry, and the European Union Tyre Label in Europe, there is an unmet need for additional reduction in the fuel efficiency of tires. One manner of determining fuel efficiency is to examine the rolling resistance of the rubber composition, which can be determined by various mechanical properties of the rubber compositions. Simply put, the lower the rolling resistance of the rubber composition, the more fuel efficient the tire will be.

Generally, it is known in the art that, by adding silica or sulfur-containing organosilane coupling agent to tire tread rubber compositions, various properties, such as wet traction and rolling resistance, can be improved. Thus, it has been shown in Japanese Patent No. 50-88 that 150 treats tire treads for winter season tire have an improved slipping resistance with a silane compound containing silica and a sulfur atom is added to the rubber compound. Likewise, European Patent No. EP 0 299 074 suggested the use of an alkoxy silane functionalized in rubber compositions comprising silica as a reinforcing filler. Similarly, U.S. Pat. No. 5,227,425, the disclosure of which is incorporated herein by reference in its entirety, disclosed tire tread compositions in which the rubber component was a copolymer of a conjugated diene and a vinyl-containing aromatic compound which was prepared in solution and in which the carbon black filler was partially or completely replaced with silica and a silane coupling agent that was added during mixing separately from the polymer.

However, these rubber compounds cannot bear the loads required for heavy vehicles, such as commercial medium trucks weighing more than 13,000 lbs. or heavy-duty trucks weighing more than 26,000 lbs. These rubber compounds are more suited for small tires, such as are used on passenger cars and light trucks.

There have been attempts to address the issue of providing high load bearing tread compositions with stress-strain properties of reinforced natural rubber that include silica to provide fuel efficient treads for use on tires for such truck or bus applications. One such attempt is provided in U.S. Patent Application Publication No. US 2020/0140661 A1, now U.S. Pat. No. 11,267,955, which discloses and claims a rubber compound containing natural rubber, a reinforcing filler such as silica that is reactive with a special silane coupling agent such as hexamethoxymethylmelamine (HMMM)-functionalized silane, and resorcinol or a resorcinol-formaldehyde resin-based secondary network. Within the patent, it is noted that phloroglucinol is referenced as a potential active hydrogen-containing compound. However, as will be set forth below, phloroglucinol is not a phloroglucinolic resin. Moreover, it is noted that this patent claims hexamethoxymethyl melamine-functionalized silane reactive with a reinforcing filler. This is believed the novelty of that patent, and it does not claim using hexamethoxymethylmelamine (HMMM) separate and apart from silane.

On the other hand, resorcinol-formaldehyde resins, also referred to as RF resins or resorcinolic resins, which are formed as the reaction product of resorcinol and formaldehyde, have been widely used in various applications including rubber compounding. In rubber compound formulations, solid RF resins have long been used to enhance rubber properties such as the adhesion properties between rubber and reinforcing materials and the dynamic properties in articles such as tires, belts and hose products.

The issue with these resins is that resorcinol resins generally have 10 to 20% unreacted or free resorcinol. The amount of free resorcinol can be a critical factor when balancing important properties, and the presence of free resorcinol can be problematic. For example, free resorcinol can volatilize during rubber mixing. Such volatilization is often referred to as fuming, and thereby creates added issues with the rubber mixing process. Further, the presence of the free resorcinol contributes to the hygroscopicity of the resorcinol resin, which in turn creates storage and handling problems.

Furthermore, formaldehyde has been used to produce resorcinol-formaldehyde resins for many years. In view of its widespread use, toxicity, and volatility, formaldehyde presents potential health and environmental problems. In 2011, the US National Toxicology Program described formaldehyde as known to be a human carcinogen. Thus, rubber compositions that included resorcinol or resorcinol-formaldehyde resin compounds are not accepted by new tire manufacturers today.

WIPO Publication No. WO2021/141934 provides for the use of phloroglucinolic resins as a substitute for resorcinol or resorcinol-formaldehyde resins, but only where no silane addivites were used. That is, like many of the other patents cited hereinabove, these resins have only been suitable for rubber compositions for use in light weight vehicle tires, as no silane additives were used in those patents or tires.

Accordingly, the need exists for the development of a high load-bearing rubber compound with the stress-strain properties of reinforced natural rubber, and the fuel efficiency of silica-based tread for use in heavy vehicle (e.g., medium to heavy-duty truck and bus) tire applications.

### SUMMARY OF THE INVENTION

To establish a highly fuel-efficient tire for heavy trucks and buses tires that does not include resorcinol or formaldehyde, rubber compound formulations consisting of natural rubber, silica, specialty silane coupling agents, hexamethoxymethylmelamine (HMMM) (separate from the silane coupling agents) and phloroglucinol resins were made. Surprisingly and unexpectedly, these rubber formulations showed much better fuel efficiency and durability compared to the compounds that included resorcinol. This invention provides a much better natural rubber-silica tread compound for truck and bus, without any resorcinol or formaldehyde.

At least one aspect of the present invention can be found in a rubber composition comprising (a) a rubbery polymer or blend of polymers; (b) at least one organosilane coupling agent; (c) at least one reinforcing filler that is reactive with the at least one organosilane coupling agent; (d) at least one methylene donor compound; (e) at least one phloroglucinol resin; and (f) at least one a sulfur-donating compound. In various embodiments, the rubber composition includes the ingredients above, wherein the rubbery component (a) ranges from about 25 to about 95 weight percent based on the total weight of the rubber composition; the organosilane coupling agent (b) ranges from 0.05 parts to 30 parts organosilane coupling agent (b), per 100 parts of the rubbery polymer; the reinforcing filler (c) that is reactive with the organosilane coupling agent (b) ranges from 1 part to 150 parts reinforcing filler, per 100 parts of the rubbery polymer; the methylene donor compound (d) ranges from 0.1 parts to 30 parts methylene donor compounds, per 100 parts of the rubbery polymer; the phloroglucinolic resin (e) ranges from 0.1 parts to 10 parts phloroglucinolic resin, per 100 parts of the rubbery polymer; and the sulfur-donating compound (f) ranges from 0.1 parts to 5 parts sulfur-donating compound, per 100 parts of the rubbery compound.

In one or more embodiments, the rubbery polymer (a) may be selected from the group consisting of natural rubber (NR), synthetic polyisoprene (IR), polybutadiene (BR), various copolymers of butadiene, the copolymers of isoprene, solution styrene-butadiene rubber (SSBR), emulsion styrene-butadiene rubber (ESBR), ethylene-propylene terpolymers (EPDM), acrylonitrile-butadiene rubber (NBR), and functionalized rubbers that are modified by at least one alkoxysilyl group, tin-containing group, amino group, hydroxyl group, carboxylic acid group, polysiloxane group, epoxy group or phthalocyanimo group. In other, more particular embodiments, the rubbery polymer includes natural rubber or a mixture of natural rubber and butadiene rubber.

In these and other embodiments, the reinforcing filler (b) may be chosen from fibers, particulates or sheet-like structures comprising metalloid oxides or metal oxides having surface hydroxyl groups. In the same or other embodiments, the reinforcing filler (b) includes precipitated silica.

In these and other embodiments, the methylene donor compound (d) may be selected from the group consisting of polyisocyanates, polyisocyanurates, epoxy resins, amino resins and polyurethanes. In these and other embodiments, an amino resin may be included and selected from the group consisting of 1,1,3,3-tetra-methoxymethylurea, 1,3,3-tris-methoxymethylurea, 1,3-bis-methoxymethylurea, 1,1-bis-methoxymethylurea, 1,1,3,3-tetra-ethoxymethylurea, 1,3,3-tris-ethoxymethylurea, 1,3-bis-ethoxymethylurea, 1,1-bis-ethoxymethylurea, 1,1,3,3-tetra-propoxymethylurea, 1,3,3-tris-propoxymethylurea, 1,3-bis-propoxymethylurea, 1,1-bis-propoxymethylurea, 1,1,3,3-tetra-butoxymethylurea, 1,1,3,3-tetra-phenoxymethylurea, N-(1,3,3-tris-ethoxymethylureidomethyl)-1,1,33-tetra-ethoxymethylurea, N,N′-bis-(1,1,3-tris-ethoxymethylureidomethyl)-1,3-bis-ethoxymethylurea, N, N′-bis-(1,1,3-tris-ethoxymethylureido-methoxymethyl)-1,3-bis-ethoxymethylurea, N,N,N′,N′,N″,N″-hexakis-methoxymethyl-[1,3,5]triazine-2,4,6-triamine, N,N,N′,N′,N″-pentakis-methoxymethyl-[1,3,5]triazine-2,4,6-triamine, N,N,N′,N″-tetrakis-methoxymethyl-[1,3,5]triazine-2,4,6-triamine, N,N,N′,N′,N″,N″-hexakis-ethoxymethyl-[1,3,5]triazine-2,4,6-triamine, N,N,N′,N′,N″-pentakis-ethoxymethyl-[1,3,5]triazine-2,4,6-triamine, N,N,N′,N″-tetrakis-ethoxymethyl-[1,3,5]triazine-2,4,6-triamine, N,N,N′,N′,N″,N″-hexakis-propoxymethyl-[1,3,5]triazine-2,4,6-triamine, N,N,N′,N′,N″-pentakis-propoxymethyl-[1,3,5]triazine-2,4,6-triamine, N,N,N′,N″-tetrakis-propoxymethyl-[1,3,5]triazine-2,4,6-triamine, N,N,N′,N′,N″,N″-hexakis-phenoxymethyl-[1,3,5]triazine-2,4,6-triamine, N,N,N′,N′,N″-pentakis-phenoxymethyl-[1,3,5]triazine-2,4,6-triamine and N,N,N′,N″-tetrakis-phenoxymethyl-[1,3,5]triazine-2,4,6-triamine.

In these and other embodiments, the phloroglucinolic resin (e) has the structure of Formula (I):

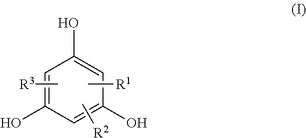

wherein at least one of R1, R2, and R3 combines with a second phloroglucinolic unit to form a di-substituted methylene bridge, wherein the second one of R1, R2, and R3 is a hydrogen atom or combines with a third phloroglucinolic unit to form another di-substituted methylene bridge, and wherein the third one of R1, R2 and R3 is a hydrogen atom. More particularly, the phloroglucinolic resin may be a solid. It will be appreciated that in one or more embodiments, the phloroglucinolic resin may have a chemical structure as described above, and as such, may have an isopropyliden bridge has the chemical structure of the di-substituted methylene bridge. In other embodiments, the phloroglucinolic resin may have a chemical structure as described above, and as such, may have a 2,2 di-substituted butane bridge as the chemical structure of the di-substituted methylene bridge. In still other embodiments, the phloroglucinolic resin may have a chemical structure as described above, and as such, may have a 2,2 di-substituted, 4-methyl pentane bridge as the chemical structure of the di-substituted methylene bridge.

It will be further appreciated that solid phloroglucinolic resin used in the rubber composition may be the reaction product of a phloroglucinol and a ketone in the presence of an acid catalyst. The ketone may be selected from the group consisting of, acetone, methyl ethyl ketone (MEK), and methyl isobutyl ketone (MIBK).

Generally, it will be appreciated that the sulfur-donating compound (f) may be sulfur.

One or more other aspects of the present invention may be found in a process for the preparation of the rubber composition as set forth above.

Still other aspects of the present invention may be found in a cured rubber composition prepared from the rubber composition as set forth above. It will be appreciated that other aspects of the invention can be obtained by an article, such as a component of a tire, comprising this cured rubber composition.

### DETAILED DESCRIPTION

Truck tires, and other heavy-duty vehicle tires include an expandable construction of multiple contractible bands of rubber and composite materials. For instance, the layer above the innerliner, consisting of thin textile fiber cords bonded into the rubber is called the carcass or casing. Carcass and casing are interchangeable terms. Many tire carcasses are one or two body plies. The tire carcass can incorporate fabric of steel, polyester, nylon or rayon cords within the carcass rubber compound. A belt system can be disposed on top of (radially outside) the carcass portion in the tire construction process. A tread slab or cap portion can be disposed on top of (radially outside) the belt system and/or carcass. The tread portion contacts the road and is formulated to enhance the performance properties and durability of the tire. Key properties include handling, traction, rolling resistance and wear resistance.

In the specification and claims herein, the following terms and expressions are to be understood as indicated.

Other than in the working examples or where otherwise indicated, all numbers expressing amounts of materials, reaction conditions, time durations, quantified properties of materials, and so forth, stated in the specification and claims are to be understood as being modified in all instances by the term “about”. Moreover, where a number in a table is provided in a claim, it will be appreciated that that number will mean “or less” where most or many of the other numbers within the same table for the same property, amount, etc. are lower than the number provided. Conversely, where a number in a table is provided in a claim, it will be appreciated that the number will mean “or more” where most or many of the other numbers within the same table for the same property, amount, etc. are higher than the number provided.

All methods described herein may be performed in any suitable order unless otherwise indicated herein or otherwise clearly contradicted by context or unless claimed in a specific order. The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

The term “for instance” is to have the same meaning as “for example.”

It will be understood that any numerical range recited herein includes all sub-ranges within that range and any combination of the various endpoints of such ranges or sub-ranges.

As used herein, integer values of stoichiometric subscripts refer to molecular species and non-integer values of stoichiometric subscripts refer to a mixture of molecular species on a molecular weight average basis, a number average basis or a mole fraction basis.

In the description that follows, all weight percentages are based upon total weight percent of the organic material(s) unless stated otherwise and all ranges given herein comprise all subranges therebetween and any combination of ranges and/or subranges therebetween.

A “rubbery polymer”, as used herein, is an organic polymer containing at least two carbon-carbon double bonds and a backbone comprising a chain or chains of carbon atoms, or mixtures thereof. In one embodiment of the invention, rubbery polymer can be at least one member selected from the group consisting of diene-based elastomers and rubbers. Rubbery polymer can be any of those that are well known in the art and are described in numerous texts, of which two examples, which are incorporated by reference herein, include The

The term rubbery polymer does not exclude that parts of the polymer could be temporarily or permanently in a partial or complete crystalline state. The terms used in this description are, to the extent possible, the same as presented in the Vanderbilt Rubber Handbook; R. F. Ohm, ed.; R.T. Vanderbilt Company, Inc., Norwalk, CT; 1990 and Manual For The Rubber Industry; T. Kempermann, S. Koch, J. Sumner, eds.; Bayer AG, Leverkusen, Germany; 1993.

The term primary network refers to a rubbery polymer network that is cross-linked via vulcanization by a cross-linker in the cure package.

The term interpenetrating network refers to the polymerization of a rubber compound ingredients within the compound without covalent interaction with the primary network.

Some representative non-limiting examples of suitable rubbery polymer, the rubber component of the composition, include those selected from the group consisting of natural rubber (NR), synthetic polyisoprene (IR), polybutadiene (BR), various copolymers of butadiene, the various copolymers of isoprene, solution styrene-butadiene rubber (SSBR), emulsion styrene-butadiene rubber (ESBR), ethylene-propylene terpolymers (EPDM), acrylonitrile-butadiene rubber (NBR) and combinations thereof. It is understood that natural rubber (NR) includes rubber from various natural plant sources, including but not limited to, rubber trees, dandelions, guayule, and so forth.

Suitable monomers for preparing the rubbery polymers herein can be selected from the group consisting of conjugated dienes such as the non-limiting examples of isoprene and 1,3-butadiene; and suitable vinyl aromatic compounds, such as the non-limiting examples of styrene and alpha methyl styrene; and combinations thereof. Rubbery polymers can be a sulfur curable rubber. The diene based elastomers, or rubbers, can be selected, to be at least one of cis-1,4-polyisoprene rubber, including natural rubber and synthetic polyisoprene rubber, and more specifically natural rubber, emulsion polymerization-prepared styrene/butadiene copolymer rubber, organic solution polymerization-prepared styrene/butadiene rubber, 3,4-polyisoprene rubber, isoprene/butadiene rubber, styrene/isoprene/butadiene terpolymer rubber, cis-1,4-polybutadiene, medium vinyl polybutadiene rubber (35-50 percent vinyl), high vinyl polybutadiene rubber (50-75 percent vinyl), styrene/isoprene copolymers, emulsion polymerization-prepared styrene/butadiene/acrylonitrile terpolymer rubber and butadiene/acrylonitrile copolymer rubber. Emulsion polymerization-derived styrene/butadiene rubbers (ESBR) are also contemplated as diene-based rubbers for use herein including those having a relatively conventional styrene content of 20 to 28 percent bound styrene or, for some applications, ESBR's having a medium to relatively high bound styrene content, namely, a bound styrene content of 28 to 45 percent. Emulsion polymerization-prepared styrene/butadiene/acrylonitrile terpolymer rubbers containing 2 to 40 weight percent bound acrylonitrile in the terpolymer are also contemplated as diene based rubbers for use herein.

The rubbery polymers can also be functionalized rubbers. Functionalized rubbers are rubbers modified by at least one functional group containing an atom other than carbon or hydrogen. The functional groups are typically alkoxysilyl groups, tin-containing groups, amino groups, hydroxyl groups, carboxylic acid groups, polysiloxane groups, epoxy groups, and the like, or combinations of these functional groups. The functional groups can be introduced into the rubbery polymer during the preparation of the synthetic rubber by co-polymerizing the monomers used to make the rubber with a monomer, initiator, or termination unit containing the functional group.

Alternatively, the rubber polymers can be modified with the functional group by grafting the functional group onto the already formed rubbery polymer.

The functionalized rubbery polymer can be used in combination with other non-functionalized rubbery polymers. The mixture can contain at least about 5 to about 95 parts per hundred parts rubber of at least one styrene-butadiene rubber, which is functionalized with at least one group selected from phthalocyanino, tin-containing groups, hydroxyl, epoxy, carboxylate, amino, alkoxysilyl and sulfido groups, where the styrene content is 0 to about 12 weight percent, and from about 5 to about 95 parts per hundred rubber of at least one further rubbery polymer. The functionalized rubbery polymers (rubber) generally have a glass transition temperature (Tg) according to DSC of −120 to −10° C. in the unvulcanized state.

In another embodiment of the invention, rubbery polymer can be a diene polymer functionalized or modified by an alkoxysilane derivative. Silane-functionalized organic solution polymerization-prepared styrene-butadiene rubber and silane-functionalized organic solution polymerization-prepared 1,4-polybutadiene rubbers may be used. These rubber compositions are known; see, for example, U.S. Pat. No. 5,821,290 the entire contents of which are incorporated by reference herein.

In yet another embodiment of the invention, rubbery polymer is a diene polymer functionalized or modified by a tin derivative. Tin-coupled copolymers of styrene and butadiene may be prepared, for example, by introducing a tin coupling agent during the styrene and 1,3-butadiene monomer copolymerization reaction in an organic solvent solution, usually at or near the end of the polymerization reaction. Such tin-coupled styrene-butadiene rubbers are well known to those skilled in the art; see, for example, U.S. Pat. No. 5,268,439, the entire contents of which are incorporated by reference herein. In practice, at least about 50 percent, and preferably from about 60 to about 85 percent, of the tin is bonded to the butadiene units of the styrene-butadiene rubbers to create a tin-dienyl bond.

Properties of natural rubber (NR) are particularly useful in the manufacture of heavy vehicle tires, bus tires and truck tires. One important reason for this is due to the combination of natural rubber's high content of cis-1, 4-poly isoprene, its large molecular weight, and its ability to undergo strain-induced crystallization. In one embodiment of the invention, rubbery polymer comprises natural rubber, or mixtures of natural rubber and synthetic rubbers. Preferably, when the rubbery polymer is a mixture of rubbers, the rubber recipe should include at least about 10 percent by weight of natural rubber, preferably about 30 percent by weight of natural rubber, more preferably at least about 50 percent by weight of natural rubber, and still even more preferably at least about 70 percent by weight of natural rubber.

Uncured rubber compositions preferably comprise a reinforcing filler. Reinforcing fillers should be materials whose moduli are higher than the rubbery polymer(s) of the rubber composition and should be capable of absorbing stress when the cured rubber composition is strained. Reinforcing fillers can be materials that are reactive with the organosilane coupling agents and can include fibers, particulates and sheet-like structures. They can be composed of inorganic minerals, silicates, silica, clays, ceramics and diatomaceous earth. The reinforcing fillers that are reactive with organosilane coupling agents can be a discrete particle or group of particles in the form of aggregates or agglomerates. The organosilane coupling agent can be reactive with the surface of the filler. Particulate precipitated silica can be useful as reinforcing filler that is reactive with the organosilanes coupling agent, particularly when the silica has reactive surface silanols. The silicas may be provided in a hydrated form or be converted to a hydrated form by reaction with water. The reinforcing filler can be used in the amount of from 1 to 150 parts reinforcing filler, per 100 parts of the rubbery polymer, more specifically from 25 to 90 parts reinforcing filler, per 100 parts of the rubbery polymer, and more specifically from 40 to 80 parts reinforcing filler, per 100 parts of the rubbery polymer.

Representative non-limiting examples of reinforcing fillers that are reactive with organosilane coupling agents include at least one metalloid oxide or metal oxide such as pyrogenic silica, precipitated silica, titanium dioxide, aluminosilicate, alumina and siliceous materials including clays and talc and combinations thereof.

In one or more embodiments herein, the reinforcing filler may be a silica used alone or in combination with one or more other fillers, e.g., organic and/or inorganic fillers that do not react with organosilane coupling agents. A representative, non-limiting example is the combination of silica and carbon black, such as for reinforcing fillers for various rubber products, including the non-limiting example of treads for tires. Alumina can be used either alone or in combination with silica. The term “alumina” herein refers to aluminum oxide, or AI2O3. Use of alumina in rubber compositions is known; see, for example, U.S. Pat. No. 5,116,886 and EP 631 982, the entire contents of both of which are incorporated by reference herein.

Reinforcing fillers that are reactive with the organosilane coupling agent may be used as a carrier for the organosilane coupling agent. Other fillers that can be used as carriers are non-reactive with organosilane coupling agents. The nonreactive nature of the fillers is demonstrated by the ability of organosilane coupling agents to be extracted at greater than 50 percent of the loaded silane using an organic solvent. The extraction procedure is described in U.S. Pat. No. 6,005,027, the entire contents of which are incorporated by reference herein. Representative of non-reactive carriers include, but are not limited to, porous organic polymers and carbon black. The amount of organosilane coupling agent that can be loaded on the carrier is preferably between 0.1 and 70 percent and more preferably between 10 and 50 percent, based on the total weight of the carrier and organosilane coupling agent.

In one non-limiting embodiment of the invention, the other fillers that may be mixed with reinforcing filler that is reactive with the organosilane coupling agent may be essentially inert to the organosilane coupling agent with which they are admixed as is the case with carbon black or organic polymers. In another embodiment, at least two reinforcing fillers that are reactive with organosilane coupling agent can be mixed together and can be reactive therewith. Reinforcing fillers that possess metalloid hydroxyl surface functionality, such as silicas and other siliceous particulates which possess surface silanol functionality, can be used in combination with reinforcing fillers containing metal hydroxyl surface functionality, such as alumina and other siliceous fillers.

In one embodiment of the invention, precipitated silica is utilized as reinforcing filler that is reactive with organosilane coupling agent. In a preferred embodiment of the invention, the silica fillers can be characterized by having a Brunauer, Emmett and Teller (BET) surface area, as measured using nitrogen gas, in the range of from about 40 to about 600 m2/g, preferably in the range of from about 50 to about 300 m2/g and more preferably in the range of from about 100 to about 220 m2/g. The BET method of measuring surface area, described in the Journal of the American Chemical Society, Volume 60, page 304 (1930), is the method used herein. In yet another preferred embodiment, the silica is typically characterized by having a dibutylphthalate (DBP) absorption value in a range of from about 100 to about 350, preferably from about 150 to about 300 and more preferably from about 200 to about 250. In other embodiments, the reinforcing filler that is reactive with the organosilane coupling agent may be alumina and aluminosilicate fillers, and possess a CTAB surface area in the range of from about 80 to about 220 m2/g. CTAB surface area is the external surface area as determined by cetyl trimethylammonium bromide with a pH of about 9; the method for its measurement is described in ASTM D 3849.

Mercury porosity surface area is the specific surface area determined by mercury porosimetry. In this technique, mercury is penetrated into the pores of the sample after a thermal treatment to remove volatiles. In a more specific embodiment, set-up conditions use a 100 milligram sample, remove volatiles over 2 hours at 105° C. and ambient atmospheric pressure and employ a measuring range of from ambient to 2000 bars pressure. Such evaluations can be performed according to the method described in Winslow, et al. in ASTM bulletin, p. 39 (1959) or according to DIN 66133; for such an evaluation, a CARLO-ERBA Porosimeter 2000 can be used. Useful reinforcing fillers that are reactive with the silane include silica, which has an average mercury porosity specific surface area in a range of from about 100 to about 300 m2/g, preferably from about 150 to about 275 m2/g and more preferably from about 200 to about 250 m2/g.

Suitable pore size distribution for reinforcing filler that are reactive with organosilane coupling agent include the non-limiting examples of silica, alumina and aluminosilicate, according to such mercury porosity evaluation, is considered herein to be five percent or less of its pores having a diameter of less than 10 nm; from about 60 to about 90 percent of its pores having a diameter of from 10 to 100 nm; from about 10 to about 30 percent of its pores having a diameter of from 100 to 1,000 nm; and, from about 5 to about 20 percent of its pores having a diameter of greater than 1,000 nm. These reinforcing fillers can normally be expected to have an average ultimate particle size in the range of from about 0.005 to about 0.075 mm, preferably of from about 0.01 to about 0.05 mm as determined by electron microscopy, although the particles can be smaller or larger in average size. Various commercially available silicas can be used herein such as those available from PPG Industries under the HI-SIL trademark, in particular, HI-SIL 210, and 243; silicas available from Solvay, e.g., ZEOSIL 1165MP; silicas available from Evonik, e.g., VN2 and VN3, etc., and silicas available from Huber, e.g., HUBERSIL 8745.

In one embodiment of the invention, the filler can comprise a reinforcing filler that is reactive with the organosilane coupling agent in the amount of from about 15 to about 95 weight percent precipitated silica, alumina and/or aluminosilicate, preferably silica and, correspondingly, from about 5 to about 85 weight percent carbon black having a CTAB value in a range of from about 80 to about 150, more preferably, the filler can comprise from about 60 to about 95 weight percent of said silica, alumina and/or aluminosilicate, preferably silica and, correspondingly, from about 40 to about 50 weight percent of carbon black. The precipitated silica, alumina and/or aluminosilicate filler and carbon black can be pre-blended or blended together during the manufacture of the vulcanized rubber. When used, carbon black can be added in amounts ranging from 0.5 parts to 10 parts carbon black, per 100 parts of the rubbery polymer.

Tire tread portions are conventionally formulated with carbon black filler. Carbon black provides tread portions with exceptional wear resistance, which leads to high mileage, long lasting tires. When silica is used as filler, the dispersion of the silica throughout the rubber matrix can be reversed to high-friction silica-silica and rubber-silica interactions. This friction can interfere with tire properties, such as rolling resistance. Adding conventional silanes to tire formulations can reduce rolling resistance by limiting internal friction of silica-silica interactions and immobilizing polymer chains on the silica surface. However, not wishing to be bound by theory, it is believed that silane bonding to the rubber chains via sulfur can increase the trans content of natural rubber, as discussed in J. I. Cuneen, Rubber Chemistry and Technology, vol. 33, page 445, 1960; and J. I. Cuneen and F. W. Shipley, Journal of Polymer Science, vol. 36, page 77, 1959. This likely adversely affects performance properties such as wear resistance. Furthermore, severely restricting chain mobility could affect the ability of natural rubber to undergo strain-induced crystallization and compromise wear resistance and tear resistance.

Conventional silanes react directly to polymer chains, and worsen critical properties of the primary rubber network. Standard amino resin-resorcinol systems can reinforce the primary polymeric network with an interpenetrating network, but can be irreversibly strained and with degradation of key properties. Without being bound by theory, it is believed that organosilanes with HMMM and phloroglucinolic resin react to build an interpenetrating network that reinforces the transfer of load from one filler to another, and decreases the friction between filler aggregates. The concentration of thermosetting interpenetrating network at the filler interface attracts the thermoset where strain is least.

Rolling resistance can be lowered by hydrophobating the silica. Increasing the effective filler volume promotes wear resistance and tear resistance. Additionally, the secondary polymeric network can increase reinforcement and stiffness of the resulting tread under static and dynamic deformations.

This load-bearing-path reinforcing interpenetrating network polymerization is believed to grow from the reinforcing filler surface, especially silica surface, which has reacted with the organosilane coupling agents. These organosilane coupling agents can function as initiators or co-initiators during the rubber mixing and/or curing process. The resulting reinforcing interpenetrating network may create additional points of physical and chemical chain entanglements for the rubber phase within the immediate surrounding of fillers. These entanglements, along with the resulting interpenetrating polymeric network and the silica, are believed to create a hierarchical structure whose modulus gradient is useful for load transfer from the rubbery polymer chains to the silica during static and dynamic deformation, thereby enhancing tear and wear resistance and reducing abrasion. The interpenetrating polymer network polymerization from the filler surface can lead to the creation of a network structure on the filler surface and increases the effective filler volume. This network structure and effective filler volume result in additional reinforcement, which is also helpful for improved wear resistance.

Without being bound by theory, it is believed that such polymeric networks are formed from reinforcing interpenetrating polymer network methylene donor compounds and phloroglucinolic resins. As a skilled person understands, an interpenetrating network can also be referred to as a secondary network. Without being bound by theory, a secondary network refers to two discrete polymer networks that are not distinguishable on a macroscale. Load-bearing-path reinforcing interpenetrating network forming phloroglucinol resin include, but are not limited to, phloroglucinol linked with di-substituted methylene linkage.

In one embodiment of the invention, methylene donor compounds are amino resins. The amino resins can be resins formed from the reaction of —NH containing compounds, formaldehyde and alcohol. More preferably, the amino resins are derived from 2,4,6-triamino-1,3,5-triazine, benzoguanamine, urea, glycoluril and poly(meth)acrylamide.

Methylene donor compounds can be used in the amount of 0.1 to 30 parts methylene donor compounds, per 100 parts of rubbery polymer, more specifically from 0.2 to 15 parts methylene donor compounds, per 100 parts of rubbery polymer, and even more specifically from 0.3 to 10 parts methylene donor compounds, per 100 parts of rubbery polymer.

Representative and non-limiting examples of the methylene donor compounds, are 1,1,3,3-tetra-methoxymethylurea, 1,3,3-tris-methoxymethylurea, 1,3-bis-methoxymethylurea, 1,1-bis-methoxymethylurea, 1,1,3,3-tetra-ethoxymethylurea, 1,3,3-tris-ethoxymethy lurea, 1,3-bis-ethoxymethylurea, 1, 1-bis-ethoxymethy lurea, 1,1,3,3-tetra-propoxymethylurea, 1,3,3-tris-propoxymethylurea, 1,3-bis-propoxymethylurea, 1,1-bis-propoxymethylurea, 1,1,3,3-tetra-butoxymethylurea, 1,1,3,3-tetra-phenoxymethylurea, N-(1,3,3-tris-ethoxymethylureidomethyl)-1,1,3,3-tetra-ethoxymethy lurea, N, N′-bis-(1,1,3-tris-ethoxymethylureidomethyl)-1,3-bis-ethoxymethylurea, N, N′-bis-(1,1,3-tris-ethoxymethylureido-methoxymethyl)-1,3-bis-ethoxymethylurea, N,N,N′,N′,N″,N″-hexakis-methoxymethyl-[1, 3, 5]triazine-2, 4, 6-triamine, N,N,N′,N′,N″-pentakis-methoxymethyl-[1,3,5]triazine-2, 4,6-triamine, N,N,N′,N″-tetrakis-methoxymethyl-[1, 3, 5]triazine-2, 4, 6-triamine, N,N,N,N′,N″,N″-hexakis-ethoxymethyl-[1, 3, 5]triazine-2, 4, 6-triamine, N,N,N′,N′,N″-pentakis-ethoxymethyl-[1,3,5]triazine-2, 4,6-triamine, N,N,N′,N″-tetrakis-ethoxymethyl-[1,3,5]triazine-2, 4, 6-triamine, N,N,N′,N′,N″,N″-hexakis-propoxymethyl-[1, 3, 5]triazine-2, 4, 6-triamine,N,N,N′,N1,N″-pentakis-propoxymethyl-[1, 3, 5]triazine-2, 4, 6-triamine, N,N,N′,N″-tetrakis-propoxymethyl-[1, 3, 5]triazine-2, 4, 6-triamine, N,N,N′,N′,N″,N″-hexakis-phenoxymethyl-[1,3,5]triazine-2, 4,6-triamine, N,N,N′,N′,N″-pentakis-phenoxymethyl-[1, 3, 5]triazine-2, 4,6-triamine, N,N,N′,N″-tetrakis-phenoxymethyl-[1, 3, 5]triazine-2, 4, 6-triamine, 1,3,4,6-tetrakis-methoxymethyl-tetrahydro-imidazo[4,5-d]imidazole-2,5-dione, 1,3,4,6-tetrakis-ethoxymethyl-tetrahydro-imidazo[4,5-J]imidazole-2,5-dione, 1,3,4,6-tetrakis-propoxymethyl-tetrahydro-imidazo[4,5-d]imidazole-2,5-dione, 1,3,4,6-tetrakis-phenoxymethyl-tetrahydro-imidazo[4,5-di]midazole-2, 5-dione, 1,3,4-tris-ethoxymethyl-tetrahydro-imidazo[4,5-d]imidazole-2, 5-dione, 1,4-bis-ethoxymethyl-tetrahydro-imidazo[4,5-d]imidazole-2,5-dione, 1,3,4,-tris-methoxymethyl-tetrahydro-imidazo[4,5-d]imidazole-2,5-dione and 1,3,4,-tris-phenoxymethyl-tetrahydro-imidazo[4,5-d]imidazole-2,5-dione.

Methylene donor compounds can be obtained commercially. For example, amino resins can be commercially purchased from PERFERE, formally INEOS Melamine GmbH, under the tradenames, RESIMENE® 747 ULF, RESIMENE®755, RESIMENE®757, RESIMENE® 764, RESIMENE® CE 8824 ULF and MAPRENAL® UF 134/60B.

In one instance, the organosilane coupling agents have the general Formula (Ia):

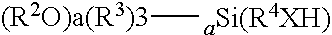

where each R2 is independently hydrogen, an alkyl group having from 1 to 10 carbon atoms and optionally at least one oxygen atom, a cycloalkyl group having from 3 to 10 carbon atoms, an alkenyl group having from 2 to 10 carbon atoms, an aryl group having from 6 to 12 carbon atoms or an aralkyl group having from 7 to 12 carbon atoms, more preferably an alkyl group having from 1 to 3 carbon atoms and even more preferably ethyl; each R3 is independently an alkyl group having from 1 to 3 carbon atoms or phenyl; R4 is an alkylene group having from 1 to 10 carbon atoms and optionally at least one oxygen atom, a cycloalkylene group having from 3 to 10 carbon atoms, an alkenylene group having from 2 to 10 carbon atoms, an arylene group having from 6 to 12 carbon atoms, an aralkylene group having from 7 to 14 carbon atoms, more preferably an alkylene group having from 1 to 6 carbon atoms, and even more preferably, a propylene; X is one or more sulfur atoms, preferably between 2 and 10, and even more preferably between 2 and 4 on average.

Representative an non-limiting examples of silane contain a functional group of Formula (Ia) include 3-mercaptopropyltrimethoxysilane, 3-merecaptopropyltriethoxysilane, 3-mercaptopropyltripropoxy silane, 3-mercaptopropy ldimethoxy ethoxy silane, 3-mercaptopropyl methyldiethoxysilane, 3-mercaptopropyldimethylethoxysilane, mercaptomethyltriethoxysilane, 4-mercapto-3,3-dimethylbutyltriethoxysilane, 3-mercaptopropylethoxy-[1,3,2]dioxasilinane, 3-mercaptopropy 1-(3-hy droxy-2-methylpropoxy)-5-methyl-[1,3,2]dioxasilinane, 6-mercaptohexyltriethoxysilane, 3-aminopropyltriethoxysilane, N-ethyl-3-aminopropyl triethoxysilane, N-methyl-3-aminopropyltriethoxysilane, N-ethyl-3,3-dimethy 1-4-aminobuty ltriethoxy silane, n-phenyl-3-aminopropy ltriethoxy silane, 3-ureidopropyltriethoxy silane, 3-ureidopropyltrimethoxy silane and mixtures thereof.

The silane coupling agent in formula (Ia) can be used in the amounts of from 0.05 to 30 parts mercaptosilane coupling agent, per 100 parts of the rubbery polymer, more specifically, from 0.5 to 15 parts mercaptosilane coupling agent, per 100 parts rubbery polymer, and even more specifically from 1 to 10 parts mercaptosilane coupling agent, per 100 parts of the rubbery polymer.

Organosilanes of formula (Ia) can be obtained commercially. For example, mercaptosilane coupling agent can be commercially purchased from Momentive Performance Materials, Inc., under the tradenames, Si263, Usi-5301, Silquest A-189, Z-6062, KBM-803. MTMO, GENIOSIL®GF 70, and S 810.

In another instance, the organosilane coupling agents are a silane that have the general Formula (Ib):

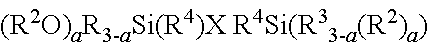

where each R2 is independently hydrogen, an alkyl group having from 1 to 10 carbon atoms and optionally at least one oxygen atom, a cycloalkyl group having from 3 to 10 carbon atoms, an alkenyl group having from 2 to 10 carbon atoms, an aryl group having from 6 to 12 carbon atoms or an aralkyl group having from 7 to 12 carbon atoms, more preferably an alkyl group having from 1 to 3 carbon atoms and even more preferably ethyl; each R3 is independently an alkyl group having from 1 to 3 carbon atoms or phenyl; R4 is an alkylene group having from 1 to 10 carbon atoms and optionally at least one oxygen atom, a cycloalkylene group having from 3 to 10 carbon atoms, an alkenylene group having from 2 to 10 carbon atoms, an arylene group having from 6 to 12 carbon atoms, an aralkylene group having from 7 to 14 carbon atoms, more preferably an alkylene group having from 1 to 6 carbon atoms, and even more preferably, a propylene; X is one or more sulfur atoms, preferably between 2 and 10, and even more preferably between 2 and 4 on average.

Representative an non-limiting examples of silane contain a functional group of Formula (Ib) include bis(tripropoxysilylpropyl)tetrasulfide; bis(triethoxysilylpropyl)tetrasulfide; bis(trimethoxysilylethyl)tetrasulfide; bis(trimethoxymethyl)tetrasulfide; bis(tripropoxysilylpropyl)disulfane; bis(triethoxysilylethyl)tetrasulfide; bis(triethoxysilylmethyl)tetrasulfide; Bis(3-triethoxysilylpropyl)disulfane; Bis[3-(triethoxysilyl)propyl]-disulfide; bis[3-(triethoxysilyl)propyl] persulfide; 3,3′-Bis-(triethoxysilylpropyl) disulfide; Bis[3-(triethoxysilyl)propyl] perdisulfide; bis(triethoxysilyl)-4,5-dithiooctane; bis(tripropoxysilylpropyl)disulfide; bis(triethoxysilylpropyl)disulfide; bis(trimethoxysilylethyl)disulfide; bis(triethoxysilylethyl)disulfide; bis(triethoxysilylmethyl)disulfide;

The silane coupling agent in formula (Ib) can be used in the amounts of from 0.05 to 30 parts organosilane coupling agent, per 100 parts of the rubbery polymer, more specifically, from 0.5 to 15 parts organosilane coupling agent, per 100 parts rubbery polymer, and even more specifically from 1 to 10 parts organosilane coupling agent, per 100 parts of the rubbery polymer.

Organosilanes of formula (Ib) with X1 representing four sulfurs on average can be obtained commercially. For example, Si69 coupling agent can be commercially purchased from Evonik. Crosile 69 TESPT can be purchased from Guangzhou Ecopower. Z6940 can be purchased from Owen Corning Corporation. A-1289 can be purchased from Momentive Performance Materials, Inc. KBE-846 can be purchased from Shin-Etsu Co. Also, organosilanes of the formula (Ib) can be purchased under tradenames Si 75, HP 1589, JH-S75, TESPD for X1 representing two sulfurs on average.

In another embodiment, the organosilane is covalently joined to the hydrogen-containing compound.

The rubber composition of the present invention may further include phloroglucinolic resin. The phloroglucinolic resin may be a solid at standard conditions. A solid phloroglucinolic resin includes a plurality of phloroglucinolic units generally defined by the formula (II)

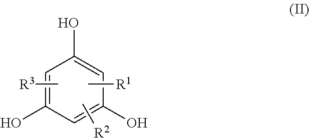

wherein at least one of R1, R2, and R3 combines with a second phloroglucinolic unit to form a di-substituted methylene bridge, wherein the second one of R1, R2, and R3 is a hydrogen atom or, combines with a third phloroglucinolic unit to form another di-substituted methylene bridge, and wherein the third one of R1, R2 and R3 may be a hydrogen atom. The structure employed in formula (II) is intended to represent the fact that the di-substituted methylene bridge(s) of R1, R2 or R3 can be bonded to the 2, 4, or 6 position on the aromatic ring. Also, the hydrogen atom of R1, R2 or R3 is also located at the 2, 4, or 6 positions. The skilled person will appreciate that any carbon atom within the aromatic ring that is not bonded to a hydroxyl group, can bond to R1, R2, or R3, and will include either a hydrogen atom or be a part of a di-substituted methylene bridge.

Generally, the di-substituted methylene bridge is linked to at least two C1 to C10 alkyl groups extending from the methylene bridge. In another embodiment, the methylene bridge includes at least two C1 to C5 alkyl groups extending therefrom. In yet another embodiment, the methylene bridge includes at least two C1 to C4 alkyl groups extending therefrom. In still another embodiment, the methylene bridge includes at least two C1 to C3 alkyl groups extending therefrom. In yet a further embodiment, the methylene bridge includes at least two C1 to C2 alkyl groups extending therefrom.

More particularly, the phloroglucinolic resin of the present invention may be described as shown in Formula (III)

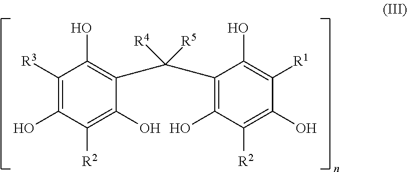

wherein R1 in the phloroglucinolic unit on the left has been replaced with a di-substituted methylene bridge as shown at the 2 position, and R3 in the phloroglucinolic unit on the right has been replaced at the 5 position. R3 on the left and R1 on the right can also be the same di-substituted methylene bridge as shown for herein, or can be a hydrogen atom, while R2 can be a hydrogen atom in this embodiment shown. R4 and R5 may be the same or different, and are alkyl groups. In one embodiment, R4 and R5 may both be methyl groups, wherein the di-substituted methylene bridge formed is an isopropyliden bridge. In another embodiment, R4 may be an ethyl group and R5 may be a methyl group, wherein the di-substituted methylene bridge formed is a 2,2 di-substituted butane bridge. In still another embodiment, R4 may be an isopropyl group and R 5 may be a methyl group, wherein the di-substituted methylene bridge formed is a 2,2 di-substituted, 4-methyl pentane bridge.

The resin is a distribution of dimers, trimers, tetramers, pentamers and over-pentamers, and monomers less than 40% can work with the resin. Phloroglucinolic resins can be used in the amounts of from 0.1 to 15 parts phloroglucinolic resin, per 100 parts of the rubbery polymer, more specifically, from 0.5 to 10 parts phloroglucinolic resin, per 100 parts rubbery polymer, and even more specifically from 1 to 5 parts phloroglucinolic resin, per 100 parts of the rubbery polymer.

A sulfur-donating compound may also be incorporated into the rubber composition. The sulfur-donating compound can be used to crosslink the rubbery polymer to form a crosslinked primary network. Without wishing to be bound by theory, the sulfur-donating compound is believed to donate sulfur atoms under curing conditions. The sulfur-donating compound generally has more than two sulfur atoms bonded together to form a chain of sulfur atoms. Polysulfides and elemental sulfur are sulfur-donating compounds, preferably sulfur, Ss.

Vulcanization can be conducted in the presence of sulfur-donating compound, often referred to as a vulcanizing agent. It reacts with the rubbery polymer containing carbon-carbon double bonds to form a crosslinked, or cured, rubber. Some non-limiting examples of suitable sulfur vulcanizing agents include, e.g., elemental sulfur (free sulfur) or sulfur-donating compound such as the non-limiting examples of amino disulfide, polymeric poly sulfide or sulfur-olefin adducts. These and other known and conventional vulcanizing agents are added in the usual amounts during a mixing step referred to as a productive mixing step in the process for preparing rubber compositions.

The sulfur-donating compounds are generally used at about 0.1 to about 5 phr, more preferably from about 1 to about 3 phr, and even more preferably from about 1.5 to about 2.5 phr.

The rubber compositions can be compounded with other commonly used additive materials such as, e.g., retarders and accelerators, processing additives such as oils, resins such as tackifying resins, plasticizers, pigments, fatty acid, zinc oxide, waxes, antioxidants and antiozonants, peptizing agents, and the like. Depending on the intended use of the rubber compositions, these and/or other rubber additives are used in conventional amounts.

Vulcanization accelerators can also be used if desired. Non-limiting examples of vulcanization accelerators include benzothiazole, alkyl thiuram disulfide, guanidine derivatives and thiocarbamates. Other examples of such accelerators include, but are not limited to, mercapto benzothiazole, tetramethyl thiuram disulfide, tetrabenzyl thiuram disulfide, benzothiazole disulfide, diphenylguanidine, zinc dithiocarbamate, alkylphenoldisulfide, zinc butyl xanthate, N-dicyclohexyl-2-benzothiazolesulfenamide, N-cyclohexyl-2-benzothiazolesulfenamide, N-oxydiethylenebenzothiazole-2-sulfenamide, N,N-diphenylthiourea, dithiocarbamylsulfenamide, N,N-diisopropylbenzothiozole-2-sulfenamide, zinc-2-mercaptotoluimidazole, dithiobis(N-methylpiperazine), dithiobis(N-beta-hydroxy ethyl piperazine) and dithiobis(dibenzyl amine). In another embodiment, other additional sulfur donors include, e.g., thiuram and morpholine derivatives. In a more specific embodiment, representative of such donors include, but are not limited to, dimorpholine disulfide, dimorpholine tetrasulfide, tetramethyl thiuram tetrasulfide, benzothiazyl-2,N-dithiomorpholide, thioplasts, dipentamethylenethiuram hexasulfide and disulfidecaprolactam.

Accelerators may be used to control the time and/or temperature required for vulcanization and to improve the properties of the vulcanizate. In one embodiment of the invention, a single accelerator system can be used, i.e., a primary accelerator. In another embodiment, conventionally and preferably, a primary accelerator(s) is used in total amounts ranging from about 0.5 to about 4 phr, and preferably from about 0.8 to about 2.0 phr. In a preferred embodiment, combinations of a primary and a secondary accelerator can be used with the secondary accelerator being used in smaller amounts, e.g., from about 0.05 to about 3 phr in order to activate and to improve the properties of the vulcanizate. In yet another embodiment, delayed action accelerators can also be used. In still another embodiment, vulcanization retarders can also be used. Suitable types of accelerators are those such as the non-limiting examples of amines, disulfides, guanidines, thioureas, thiazoles, thiurams, sulfenamides, dithiocarbamates, xanthates and combinations thereof. In a preferred embodiment, the primary accelerator is a sulfenamide. In another embodiment, if a second accelerator is used, the secondary accelerator can be a guanidine, dithiocarbamate or thiuram compound, such as for example tetrabenzyl thiuram disulfide used at levels from about 0.1 to about 0.3 phr, more preferably about 0.2 phr.

Optional tackifier resins can be used at levels of from about 0.5 to about 10 phr and preferably from about 1 to about 5 phr. In a preferred embodiment, the amounts of processing aids range from about 1 to about 50 phr. Suitable processing aids can include, as non-limiting examples, aromatic, naphthenic and/or paraffinic processing oils and combinations thereof. In yet another embodiment, preferred amounts of antioxidants are from about 1 to about 5 phr. Representative antioxidants include, as non-limiting examples, diphenyl-p-phenylenediamine and others, e.g., those disclosed in the Vanderbilt Rubber Handbook (1978), pages 344-346, which is incorporated by reference herein. In yet another embodiment, preferred amounts of antiozonants range from about 1 to about 5 phr. Preferred amounts of optional fatty acids, which can include the non-limiting example of stearic acid, range from about 0.5 to about 3 phr.

Preferred amounts of zinc oxide range from about 2 to about 5 phr. Preferred amounts of waxes, e.g., microcrystalline wax, range from about 1 to about 5 phr. Preferred amounts of peptizers range from about 0.1 to about 1 phr. Suitable peptizers include, as non-limiting examples, pentachlorothiophenol, dibenzamidodiphenyl disulfide and combinations thereof.

In one embodiment of the invention, the rubber compositions contain phloroglucinolic resins, and the rubber composition preferably comprises (a) at least one rubbery polymer used to form a primary network, (b) at least one reinforcing filler that is capable of reacting with the organosilane coupling agent; (c) at least one load-bearing-path reinforcing interpenetrating network forming methylene donor compound; (d) at least one organosilane coupling agent that can be reacted with the reinforcing filler, (e) at least phloroglucinol resin and (f) at least one sulfur-donating compound, especially sulfur (Ss) or at least one sulfur-donating compound, especially sulfur (Ss). The rubbery polymer may comprise one or more rubber components in which the rubber components add up to about 100 phr (parts per hundred rubber). In one embodiment of the invention, natural rubber should be about 50 to 100 phr of the primary polymer blend portion of the rubber composition, preferably about 75 to 100 phr. The reinforcing filler may comprise about 1 to about 150 phr of the rubber composition, preferably from about 15 to 90 phr, more preferably from about 20 to 55 phr. In one embodiment of the invention, the reinforcing filler is silica, preferably precipitated silica. The organosilane coupling agent itself and/or the materials for forming the load-bearing-path reinforcing interpenetrating network (network forming methylene donor and phloroglucinol resin) can comprise from about 6 to 50% of reinforcing filler weight portion of the formulation, preferably from about 8 to 25% of the reinforcing filler weight, more preferably about 12 to 25% of the reinforcing filler weight in the formulation.

Thus, in one or more embodiments, the rubber composition comprises:
(a) a rubbery polymer or blend of polymers;
(b) at least one organosilane coupling agent;
(c) at least one reinforcing filler that is reactive with the organosilane coupling agent;
(d) at least one methylene donor resin;
(e) at least one phloroglucinolic resin; and
(f) optionally, at least one a sulfur-donating compound.

In another embodiment, the rubber composition comprises the rubbery component in an amount of from about 25 to about 95 weight percent based on the total weight of the rubber composition, the reinforcing filler that is reactive with the organosilane coupling agent in an amount of from about 2 to about 70 weight percent based on the total weight of rubber composition, methylene doner resin in the amount of from about 0.2 to about 25 weight percent based on the total weight of the rubber composition, the phloroglucinolic resin in the amount of from about 0.2 to about 25 weight percent based on the total weight of the rubber composition and the amount of the sulfur-donating compound in an amount of from about 0.2 to about 5 weight percent based on the total

In the cured rubber composition, the primary polymeric network is cured to form a crosslinked rubber polymer or crosslinked blend of polymers by subjecting the rubber composition to an elevated temperature for a time sufficient to react the rubber polymer or blend or rubber polymers (a) with the at least one sulfur-donating compound.

In another embodiment of the invention, the process for providing the rubber compositions described herein involves the mixing the at least one reinforcing filler, the at least one methylene donor resin, the at least one organosilane coupling agent, the at least one phloroglucinolic resin, and optionally, the at least one sulfur donating compound with a rubbery component, such as natural rubber, in effective amounts. In one embodiment of a process in accordance with the invention, an effective amount of organosilane coupling agent can range from about 0.2 to about 20, preferably from about 0.5 to about 15 and more preferably from about 2 to about 10, weight percent based on the total weight of rubber composition. An effective amount of rubbery component can range from about 25 to about 95, preferably from about 50 to about 90 and more preferably from about 60 to about 80, weight percent based on the total weight of the rubber composition. An effective amount of the reinforcing filler that is reactive with the organosilane coupling agent can range from about 2 to about 70, preferably from about 5 to about 55 and more preferably from about 20 to about 50, weight percent based on the total weight of rubber composition. An effective amount of organic resin can range from about 0.2 to about 25 weight percent, preferably from about 2 to about 15 weight percent and more preferably from about 5 to about 10, weight percent based on the total weight of the rubber composition. An effective amount of the active hydrogen-containing compound (e) can range from about 0.2 to about 25 weight percent, preferably from about 2 to about 15 weight percent and more preferably from about 5 to about 10, weight percent based on the total weight of the rubber composition. An effective amount of the sulfur-donating compound can range from about 0.2 to about 5, preferably from about 0.5 to about 2.5 and more preferably from about 1 to about 2, weight percent based on the total weight of the rubber composition.

In another embodiment of the invention, the process for preparing a rubber composition can optionally comprise curing the rubber composition, before, during and/or after molding the rubber composition. A vulcanized rubber composition should contain a sufficient amount of the load-bearing-path reinforcing interpenetrating network to contribute to a higher modulus and better wear.

In one embodiment of the invention, the organosilane coupling agent is added separately to the process mixture containing rubbery polymer component. Reinforcing filler and organosilane coupling agent can be considered to couple or react in situ to form a reinforcing filler in which the organosilane coupling agent is chemically bonded to the filler.

In one embodiment of the invention, the process for preparing the rubber compositions comprise multiple steps. In the non-productive step (i), the rubbery component, reinforcing filler, methylene donor resin, and organosilane are mixed under reactive-mechanical-working conditions. As used herein, the expression “reactive-mechanical-working conditions” shall be understood to mean the conditions of elevated temperature, residence time and shear prevailing within a mechanical-working apparatus, such as an extruder, intermeshing mixer, or tangential mixer, such conditions being sufficient to bring about one or more of the following.

The reactive process of hydrolysis of organosilane coupling agent with water, which is present on the reinforcing filler, may form alkoxymethylamino-functional silanols. The reactive process of these silanols with reinforcing filler may form covalent chemical bonds with the filler. There may be a breakdown of reinforcing filler agglomerates into smaller aggregates and/or individual filler particles. Upon dispersion into the rubbery polymer, the reinforcing filler may be covalently bonded to hydrolyzed and subsequently condensed alkoxymethylamino-functional silane.

In the non-productive step (ii), methylene donor and the phloroglucinol resin are added to the mixture of step (i). In the non-productive step (ii), components all the components (except sulfur donating compound in this embodiment) are mixed under reactive-mechanical-working conditions, where the conditions of elevated temperature, residence time and shear prevailing within a mechanical-working apparatus, such as an extruder, intermeshing mixer, or tangential mixer, such conditions being sufficient to bring about one or more of the following, namely, the dispersion into the mixture of the rubbery polymer, reinforcing filler covalently bonded to hydrolyzed and subsequently condensed, organosilane coupling agent of step (i) methylene donor and phloroglucinol resin; and/or the reaction of the reinforcing filler covalently bonded to hydrolyzed and subsequently condensed organosilane coupling agent with the methylene donor and the phloroglucinol resin; and/or optionally, the reaction of methylene donor with the phloroglucinol resin to form the load-bearing-path reinforcing interpenetrating network dispersed within the primary network and provide for uncured rubber composition.

If either the methylene donor or the phloroglucinolic resin are not added in step (ii), then the missing ingredient can be added in a second non-productive mixing step (ii).

In the productive step (iii), the sulfur-donating compound (f) is added to the mixture of step (ii).

In any of steps (i), (ii) or (iii), other components can be added to the rubber composition. Representative and non-limiting examples of other components include activators, processing aids, accelerators, waxes, oils, anti-ozonants and anti-oxidants,

The rubber composition is typically mixed in a mixing apparatus under high shear conditions where it autogenously heats up as a result of the mixing, primarily due to shear and associated friction occurring within the rubber mixture.

In a preferred embodiment of the invention, the mixture of the desired amounts of the rubbery polymer, the reinforcing filler, the methylene donor and the organosilane coupling agent of step (i) is substantially homogeneously blended under reactive-mechanical-working conditions in mixing step (i) carried out on a continuous or non-continuous basis. Non-continuous mixing can be employed where a build-up of excessive heat might occur and the rubber composition may need to be cooled. Cooling of the rubber will avoid or minimize thermal decomposition of rubbery polymer component(s) or other components in the rubber composition. Preferably, mixing step (i) is conducted at temperatures from 100° C. to 200° C. and more preferably from 140° C. to 180° C.

In step (iii), at least one sulfur-donating compound (f) along with other vulcanization accelerators, can be mixed with the rubber composition from step (ii). Mixing should be accomplished under non-reactive-mechanical-working conditions. As used herein, the expression “non-reactive-mechanical-working” conditions shall be understood to mean the conditions of sub-ambient, ambient or slightly elevated temperature, residence time and shear prevailing within a mechanical-working apparatus, such as an extruder, intermeshing mixer, tangential mixer, or roll mill, such conditions being sufficient to bring about dispersion of the sulfur-donating compound, e.g. vulcanizing agent, and vulcanization accelerators into the rubber composition of step (ii) without resulting in any appreciable vulcanization of the rubber composition. Low temperatures and low shear are advantageously employed in step (iii).

In step (iii), residence time can vary considerably and is generally chosen to complete the dispersion of the vulcanizing agent. Residence times in most cases can range from 0.5 to 30 minutes and preferably from 5 to 20 minutes.

The temperature employed in step (iii) can range from 5° C. to 150° C., preferably from 30° C. to 120° C. and more preferably from 50° C. to 110° C. These temperatures are lower than those utilized for reactive-mechanical-working conditions in order to prevent or inhibit premature curing of the sulfur-curable rubber, sometimes referred to as scorching of the rubber composition, which might take place at higher temperatures.

The rubber composition may be allowed to cool, e.g., during or after step (iii) or between step (i) and step (ii) or between step (ii) and step (iii), to a temperature of 50° C. or less.

In another embodiment of the invention, when it is desired to mold and to cure the rubber composition, the rubber composition is placed in the desired mold and heated to at least about 130° C. and up to about 200° C. for a time of from 1 to 60 minutes to bring about the vulcanization of the rubber.

Rubber compositions preferred for forming tire tread portions in accordance with preferred embodiments of the invention comprise (a) a rubbery primary polymer or blend of polymers, (b) reinforcing silica filler particles, (c) an methylene donor capable of forming a load-bearing-path reinforcing interpenetrating network, which can be generated in-situ, (d) a organosilane coupling agent which can react with the reinforcing filler and/or (e) an active hydrogen-containing compound, namely, at least one phloroglucinolic resin, in which components (b), (c), (d) and (e) contribute to the aforementioned load-bearing-path reinforcing interpenetrating network.

The rubber composition herein can be used for various purposes. In one embodiment of the invention, there is provided an article of which at least one component is the herein described cured rubber composition. In another embodiment herein, there is provided a tire at least one component of which, e.g., the tread, is the herein described cured rubber composition.

In yet another preferred embodiment, for example, the rubber composition can be used for the manufacture of such articles as shoe soles, hoses, seals, cable jackets, gaskets and other industrial goods. Such articles can be built, shaped, molded and cured by various known and conventional methods as is readily apparent to those skilled in the art. In particular, the compositions and methods in accordance with the invention are particularly well suited for the manufacture of tires, in particular, truck or bus tires.

### EXAMPLES

In order to demonstrate the practice of the present invention, the following examples have been prepared and tested. The examples should not, however, be viewed as limiting the scope of the invention. The claims will serve to define the invention. The abbreviation PG means “Phloroglucinolic.”

### PG Resin Example 1

440.0 g of phloroglucinol, 628.7 g of acetone and 349.3 g of acid cation exchange catalyst (DIAION PK212LH, Mitsubishi Chemical Corporation) were charged to a flask and heated to 70° C. The reaction mixture was maintained at about 70° C. for 24 hours. Then, 0.4 g of a 25% solution of sodium hydroxide was added. Solvent was then removed by vacuum distillation to 155° C. When a temperature of 155° C. was reached, the vacuum was released and the resin was discharged from the flask.

Table 1 lists the ingredients used for preparing rubber compositions using Natural Rubber. The compositions contain silica coupled with bis[3-(triethoxysilyl)propyl]tetrasulfide (TESPT) or mercaptosilane coupling agent, methylene donor compounds and resorcinol or resorcinol resin as controls. The compositions contain mercaptosilane coupling agent, methylene donor compounds and synthesized phloroglucinol resin. “Non-productive” combinations refer to combinations of materials that are not cured and “productive” combinations are used to result in cured compositions. For explaining current arts for truck bus tire tread, the compositions contain N121 carbon black are also prepared.

All four formulations (TESPT, Mercaptosilane couplig agent, hexa(methoxymethyl) melamine with Resorcinol or Penacolite, and Mercaptosilane coupling agent hexa(methoxymethyl) melamine with phloroglucinol resin, were mixed in an internal rubber mixer utilizing a mixing procedure involving three sequential non-productive mixing steps followed by a final productive (curative) mix. The silica formulation containing TESPT was heat treated for 150 secs at 145° C. during all 3 non-productive passes. The silica formulation containing methylene donor compound with resins was heat treated for 150 secs at 155° C. during the 1st non-productive, for 150 sees at 150° C. for the 2nd non-productive, and for 150 sees at 140° C. for the 3rd non-productive step. The hexa(methoxymethyl) melamine and resorcinol, Penacolite or Phloroglucinol resin for the in-situ polymerization of the load-bearing-path reinforcing interpenetrating network were added in the 2nd and 3rd non-productive stages, respectively. The phr loading for hexa(methoxymethyl)melamine and resorcinol are optimized values to ensure that the Shore A Hardness for the cured compounds are within the typical range for a truck tire formulation (Shore A Hardness of 60-65) and to achieve the best balance of physical and dynamic properties. The rubber compositions shown in Table 1 were cured at 160° C. for 15 minutes. The resulting dynamic and physical properties are shown below in Table 2 and Table 3 respectively.

TABLE 1

| | Sam- | Sam- | Sam- | Sam- | Sam- |
|---|---|---|---|---|---|
| | ple 1 | ple 2 | ple 3 | ple 4 | ple 5 |
| 1st Non- | | | | | |
| Productive | | | | | |
| Natural Rubber¹ | 100 | 100 | 100 | 100 | 100 |
| Silica² | 50 | 50 | 50 | 50 | 0 |
| Carbon Black³ | 5 | 5 | 5 | 5 | 30 |
| TDAE Process | 1 | 1 | 1 | 1 | 1 |
| Oil | | | | | |
| TESPT silane | 4 | 0 | 0 | 0 | 0 |
| Hexa(methoxy- | 0 | 3.7 | 3.7 | 3.7 | 0 |
| methyl)melamine | | | | | |
| (HMMM) | | | | | |
| (3-Mercapto- | 0 | 2.3 | 2.3 | 2.3 | 0 |
| propyl)trieth- | | | | | |
| oxysilane | | | | | |
| Zinc Oxide | 1.5 | 1.5 | 1.5 | 1.5 | 1.5 |
| Stearic Acid | 1 | 1 | 1 | 1 | 1 |
| NP1 Total | 162.5 | 164.5 | 164.5 | 164.5 | 133.5 |
| 2nd Non- | | | | | |
| Productive | | | | | |
| Carbon Black³ | 5 | 5 | 5 | 5 | 25 |
| 6PPD⁴ | 2 | 2 | 2 | 2 | 2 |
| TMQ⁵ | 0.5 | 0.5 | 0.5 | 0.5 | 0.5 |
| Microcrystalline | 1.3 | 1.3 | 1.3 | 1.3 | 1.3 |
| Wax | | | | | |
| Zinc Oxide | 1.5 | 1.5 | 1.5 | 1.5 | 1.5 |
| Stearic Acid | 1 | 1 | 1 | 1 | 1 |
| Hexa(methoxy- | 0 | 1.25 | 1.25 | 1.25 | 0 |
| methyl)melamine | | | | | |
| (HMMM) | | | | | |
| NP2 Total | 173.8 | 177.05 | 177.05 | 177.05 | 164.8 |
| 3rd Non- | | | | | |
| Productive | | | | | |
| Resorcinol | 0 | 0.63 | 0 | 0 | 0 |
| Penacolite Resin | 0 | 0 | 1.1 | 0 | 0 |
| B-19-SC | | | | | |
| Phloroglucinol | 0 | 0 | 0 | 1.1 | 0 |
| Resin 1 | | | | | |
| NP3 Total | 173.8 | 177.68 | 178.15 | 178.15 | 164.8 |
| Productive | | | | | |
| Sulfur | 1.6 | 1.6 | 1.6 | 1.6 | 1.6 |
| CBS⁶ | 1.1 | 1.1 | 1.1 | 1.1 | 0.6 |
| DPG⁷ | 0.4 | 0.4 | 0.4 | 0.4 | 0.4 |
| FM Total | 176.9 | 180.78 | 181.25 | 181.25 | 167.4 |

¹Natural Rubber cis 1,4-polyisoprene- as SIR 20-Standard: Indonesian Rubber
²Zeosil 1165MP-Solvay
³N121 Carbon black-Columbia Chemicals Company
⁴N-1,3-dimethylbutyl-N-phenyl-para-phenylenediamine-Harwick Standard Distribution corp.
⁵2,2,4-Trimethyl-1,2,-Dihydroquinoline polymer-NOCIL
⁶N-Cyclohexyl-2-benzothiazole sulfonamide-Harwick Standard Distribution corp.
⁷Diphenylguanidine- Harwick Standard Distribution corp.

TABLE 2

| Compound | tanD @ 60° C. |
|---|---|
| Sample 5 | 0.132827 |
| Sample 1 | 0.116699 |
| Sample 2 | 0.101557 |
| Sample 3 | 0.105222 |
| Sample 4 | 0.089646 |

TABLE 3

| Compound | DIN Abrasion |
|---|---|
| Sample 5 | 116 |
| Sample 1 | 229 |
| Sample 2 | 171 |
| Sample 3 | 137 |
| Sample 4 | 141 |

The compound contained mercaptosilane coupling agent, methylene donor compounds and resorcinol or resorcinol resin showed better wear and abrasion resistance compared with TESPT compound, as measured using both a DIN abrader and an Angle Abrader (at both 12° and 16° slip angles under a normal load of 61N and 123N, respectively, using grindstone as the grinding surface). However, unexpectedly and surprisingly, the compound containing mercaptosilane coupling agent, methylene donor compounds and phloroglucinol resin showed much better rolling resistance properties (tan D at 60 C) compared to the others as measured using dynamic mechanical analysis, Metravib. It means this invention achieved not only obtained NR/silica tread system without resorcinol but also made the progress of improvement of low rolling resistance.

It will be appreciated that PG RESIN 1 performed unexpectedly well with a rolling resistance 48% better than the carbon black control, 30% better than penacolite, 13% better than resorcinol, 17% better than TESPT, while maintaining DIN abrasion of the PG RESIN EXAMPLE 1 compound at 62% improvement upon TESPT, 21% improvement on resorcinol, and comparable to penacolite.

### PG Resin Example 2

440.0 g of phloroglucinol, 628.7 g of acetone and 349.3 g of acid cation exchange catalyst (DIAION PK212LH, Mitsubishi Chemical Corporation) were charged to a flask and heated to 70° C. The reaction mixture was maintained at about 70° C. for 24 hours. Then, 0.4 g of a 25% solution of sodium hydroxide was added. Solvent was then removed by vacuum distillation to 155° C. When a temperature of 155° C. was reached, the vacuum was released and the resin was discharged from the flask.

Table 2 lists the ingredients used for preparing rubber compositions using Natural Rubber. The compositions contain silica coupled with TESPT coupling agent, methylene donor compounds and phloroglucinol resin similar to the previous example as controls. The compositions contain methylene donor compounds in high and low amounts, TESPT in high and low amounts and synthesized phloroglucinol resin in high and low amounts. “Non-productive” combinations refer to combinations of materials that are not cured and “productive” combinations are used to result in cured compositions with low and high sulfur amounts.

All three formulations (normal sulfur, high sulfur, low sulfur), were mixed in an internal rubber mixer utilizing a mixing procedure involving three sequential non-productive mixing steps followed by a final productive (curative) mix. All three formulations were subjected with the same process. They consisted of mixing in the first pass at 65 rpm for 3 mins to ensure incorporation, and for another three minutes at 80 rpm to complete additive distribution. The mixing of the first masterbatch is completed with a two minute silanization at 160° C. for 2 minutes. The second pass is a two minute mix at 140 C and 1.5 min hold at 140° C. and dump. The third mixing pass consists of 1.5 minutes of mixing at 40 rpm followed by a 1 min temperature hold at 100° C. The productive step was mixed for 1.5 min and held for one minute at 100° C. The phr values of silane, HMMM, TESPT, resin and sulfur were adjusted to yield similar physical properties.

TABLE 4

| | Sample 1 | Sample 2 | Sample 3 |
|---|---|---|---|
| 1st Non-Productive | | | |
| Natural Rubber¹ | 100 | 100 | 100 |
| Silica² | 50 | 50 | 50 |
| Carbon Black N121³ | 5 | 5 | 5 |
| TDAE Oil | 1 | 1 | 1 |
| Si69 | 4 | 1 | 12 |
| MB1 Total | 160 | 157 | 168 |
| 2nd Non-Productive | | | |
| Carbon Black N121 | 5 | 5 | 5 |
| 6PPD⁴ | 2 | 2 | 2 |
| TMQ⁵ | 0.5 | 0.5 | 0.5 |
| Microcrystalline Wax | 1.3 | 1.3 | 1.3 |
| ZnO | 3 | 3 | 3 |
| Stearic Acid | 2 | 2 | 2 |
| PG Resin Example 2 | 1.1 | 0.3 | 3.3 |
| MB2 Total | 174.9 | 171.1 | 185.1 |
| 3rd Non-Productive | | | |
| HMMM | 5 | 1 | 15 |
| MB3 Total | 179.9 | 172.1 | 200.1 |
| Productive | | | |
| Sulfur | 1.6 | 4 | 0.4 |
| CBS⁶ | 1.1 | 0.5 | 1.8 |
| DPG⁷ | 0.4 | 0.4 | 0.4 |
| Final Total | 183 | 177 | 202.7 |

¹Natural Rubber cis 1,4-polyisoprene- as SIR 20-Standard: Indonesian Rubber
²Ultrasil 7000 GR
³N121 Carbon black-Columbia Chemicals Company
⁴N-1,3-dimethylbutyl-N-phenyl-para-phenylenediamine-Harwick Standard Distribution corp.
⁵2,2,4-Trimethyl-1,2,-Dihydroquinoline polymer-NOCIL
⁶N-Cyclohexyl-2-benzothiazole sulfonamide-Harwick Standard Distribution corp.
⁷Diphenylguanidine- Harwick Standard Distribution corp.

TABLE 5

| Compound | tanD@60 C. |
|---|---|
| Sample 1 | 0.073 |
| Sample 2 | 0.070 |
| Sample 3 | 0.072 |

TABLE 6

| Compound | Hardness |
|---|---|
| Sample 1 | 65 |
| Sample 2 | 64.8 |
| Sample 3 | 64.8 |

TABLE 7

| Compound | 300% Modulus |
|---|---|
| Sample 1 | 16.8 |
| Sample 2 | 16.7 |
| Sample 3 | 16.9 |

TABLE 8

| Compound | Elongation % |
|---|---|
| Sample 1 | 488 |
| Sample 2 | 505 |
| Sample 3 | 493 |

All three experimental compounds showed comparable physical properties. Without being bound by theory, the high sulfur was compensated with low levels of interpenetrating network monomers. The low sulfur compound was compensated by high levels of interpenetrating network ingredients. Unexpectedly, the load bearing path interpenetrating network can fully compensate for the primary network over a broad range of addition.

As a person skilled in the art would understand, hardness is a predictor of wear performance in DIN abrasion test.

Various modifications and alterations that do not depart from the scope and spirit of this invention will become apparent to those skilled in the art. This invention is not to be duly limited to the illustrative embodiments set forth herein.

What is claimed is:

1. A rubber composition comprising:
(a) a rubbery polymer or blend of polymers;
(b) at least one organosilane coupling agent;
(c) at least one reinforcing filler that is reactive with the at least one organosilane coupling agent;
(d) at least one methylene donor compound;
(e) at least one phloroglucinolic resin; and
(f) at least one a sulfur-donating compound.

2. The rubber composition of claim 1, wherein the rubbery component (a) ranges from about 25 to about 95 weight percent based on the total weight of the rubber composition; the organosilane coupling agent (b) ranges from 0.05 parts to 30 parts organosilane coupling agent (b), per 100 parts of the rubbery polymer; the reinforcing filler (c) that is reactive with the organosilane coupling agent (b) ranges from 1 part to 150 parts reinforcing filler, per 100 parts of the rubbery polymer; the methylene donor compound (d) ranges from 0.1 parts to 30 parts methylene donor compounds, per 100 parts of the rubbery polymer; the phloroglucinolic resin (e) ranges from 0.1 parts to 10 parts phloroglucinolic resin, per 100 parts of the rubbery polymer; and the sulfur-donating compound (f) ranges from 0.1 parts to 5 parts sulfur-donating compound, per 100 parts of the rubbery compound.

3. The rubber composition of claim 2, wherein the rubbery polymer (a) is selected from the group consisting of natural rubber (NR), synthetic polyisoprene (IR), polybutadiene (BR), various copolymers of butadiene, the copolymers of isoprene, solution styrene-butadiene rubber (SSBR), emulsion styrene-butadiene rubber (ESBR), ethylene-propylene terpolymers (EPDM), acrylonitrile-butadiene rubber (NBR), and functionalized rubbers that are modified by at least one alkoxysilyl group, tin-containing group, amino group, hydroxyl group, carboxylic acid group, polysiloxane group, epoxy group or phthalocyanimo group.

4. The rubber composition of claim 2, wherein the rubbery polymer (a) comprises natural rubber or a mixture of natural rubber and butadiene rubber.

5. The rubber composition of claim 2, wherein the reinforcing filler (c) is chosen from fibers, particulates or sheet-like structures comprising metalloid oxides or metal oxides having surface hydroxyl groups.

6. The rubber composition of claim 5, wherein the reinforcing filler (c) comprises precipitated silica.

7. The rubber composition of claim 2, wherein the methylene donor compound (d) is selected from the group consisting of polyisocyanates, polyisocyanurates, epoxy resins, amino resins and polyurethanes.

8. The rubber composition of claim 7, wherein the amino resin is selected from the group consisting of 1,1,3,3-tetra-methoxymethylurea, 1,3,3-tris-methoxymethylurea, 1,3-bis-methoxymethylurea, 1,1-bis-methoxymethylurea, 1,1,3,3-tetra-ethoxymethylurea, 1,3,3-tris-ethoxymethylurea, 1,3-bis-ethoxymethylurea, 1,1-bis-ethoxymethylurea, 1,1,3,3-tetra-propoxymethylurea, 1,3,3-tris-propoxymethylurea, 1,3-bis-propoxymethylurea, 1,1-bis-propoxymethylurea, 1,1,3,3-tetra-butoxymethylurea, 1,1,3,3-tetra-phenoxymethylurea, N-(1,3,3-tris-ethoxymethylureidomethyl)-1,1,33-tetra-ethoxymethylurea, N, N′-bis-(1,1,3-tris-ethoxymethylureidomethyl)-1,3-bis-ethoxymethylurea, N, N′-bis-(1,1,3-tris-ethoxymethylureido-methoxymethyl)-1,3-bis-ethoxymethylurea, N,N,N′,N′,N″,N″-hexakis-methoxymethyl-[1,3,5]triazine-2,4,6-triamine, N,N,N′,N′,N″-pentakis-methoxymethyl-[1,3,5]triazine-2,4,6-triamine, N,N,N′,N″-tetrakis-methoxymethyl-[1,3,5]triazine-2,4,6-triamine, N,N,N′,N′,N″,N″-hexakis-ethoxymethyl-[1,3,5]triazine-2,4,6-triamine, N,N,N′,N′,N″-pentakis-ethoxymethyl-[1,3,5]triazine-2,4,6-triamine, N,N,N′,N″-tetrakis-ethoxymethyl-[1,3,5]triazine-2,4,6-triamine, N,N,N′,N′,N″,N″-hexakis-propoxymethyl-[1,3,5]triazine-2,4,6-triamine, N,N,N′,N′,N″-pentakis-propoxymethyl-[1,3,5]triazine-2,4,6-triamine, N,N,N′,N″-tetrakis-propoxymethyl-[1,3,5]triazine-2,4,6-triamine, N,N,N′,N′,N″,N″-hexakis-phenoxymethyl-[1,3,5]triazine-2,4,6-triamine, N,N,N′,N′,N″-pentakis-phenoxymethyl-[1,3,5]triazine-2,4,6-triamine and N,N,N′,N″-tetrakis-phenoxymethyl-[1,3,5]triazine-2,4,6-triamine.

9. The rubber composition of claim 2, wherein the phloroglucinolic resin (e) has the structure of Formula (I): 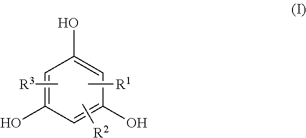
wherein at least one of R1, R2, and R3 combines with a second phloroglucinolic unit to form a di-substituted methylene bridge, wherein the second one of R1, R2, and R3 is a hydrogen atom or combines with a third phloroglucinolic unit to form another di-substituted methylene bridge, and wherein the third one of R1, R2 and R3 is a hydrogen atom.

10. A rubber composition of claim 9, wherein the phloroglucinolic resin is a solid, and wherein the phloroglucinolic resin has a chemical structure as set forth in claim 9, wherein the di-substituted methylene bridge formed is an isopropyliden bridge.

11. A rubber composition of claim 9, wherein the phloroglucinolic resin is a solid, and the phloroglucinolic resin has a chemical structure as set forth in claim 9, wherein the di-substituted methylene bridge formed is a 2,2 di-substituted butane bridge.

12. A rubber composition of claim 9, wherein the phloroglucinolic resin is a solid, and wherein the phloroglucinolic resin has a chemical structure as set forth in claim 9, wherein the di-substituted methylene bridge formed is a 2,2 di-substituted, 4-methyl pentane bridge.

13. The rubber composition of claim 2, wherein the solid phloroglucinolic resin is the reaction product of a phloroglucinol and a ketone in the presence of an acid catalyst.

14. The rubber composition of claim 12, wherein the solid phloroglucinolic resin as claimed in claim 12, wherein the ketone is selected from the group consisting of, acetone, methyl ethyl ketone (MEK), and methyl isobutyl ketone (MIBK).

15. The rubber composition of claim 2, wherein the sulfur-donating compound (f) is sulfur.

16. A process for the preparation of the rubber composition of claim 2.

17. A cured rubber composition prepared from the composition of claim 2.

18. An article comprising the cured rubber composition of claim 17.

19. The article of claim 18, wherein said article is a component of a tire.
